(19) United States
(12) Patent Application Publication
(10) Pub. No.: US 2005/0055365 A1
(43) Pub. Date: Mar. 10, 2005

(54) Scalable data extraction techniques for transforming electronic documents into queriable archives

(76) Inventors: I.V. Ramakrishnan, Stony Brook, NY (US); Saikat Mukherjee, Stony Brook, NY (US); Guizhen Yang, Buffalo, NY (US); Hasan Davulcu, Tempe, AZ (US)

Correspondence Address: Frank Chau;F. CHAU & ASSOCIATES, LLP, Suite 501, 1900 Hempstead Turnpike, East Meadow, NY, 11554, US

(21) Appl. No.: 10/658,312

(22) Filed: Sep. 9, 2003

(51) Int. Cl. G06F 17/00

(52) U.S. Cl. 707/102

(57) ABSTRACT

A method for extracting an attribute occurrence from template generated semi-structured document comprising multi-attribute data records comprises identifying a first set of attribute occurrences in the template generated semi-structured document using an ontology. The method further comprises determining a boundary of each multi-attribute data record in the template generated semi-structured document, learning a pattern for an attribute corresponding to an identified attribute occurrence of the first set in the template generated semi-structured document, and applying the pattern within the boundary of each multi-attribute data record in the template generated semi-structured document to extract a second set of attribute occurrences.

### BACKGROUND OF THE INVENTION

1. Field of the Invention

The present invention relates to data extraction, and more particularly to ontology-based data extraction.

2. Discussion of the Related Art

The global reach of the Web has made it the medium of choice for promoting a plethora of products and services. Realizing the significant market and business opportunities the web provides, vendors use it to advertise their product offerings, service providers use it to publish their services, and manufacturers use it to post specification and performance data sheets of their products.

Machine learning techniques are playing an increasingly important role in data extraction from semi-structured sources, the primary reason being that they improve recall and demonstrate potential for being fully automatic and highly scalable. To date the relationship between learning algorithms and their impact on recall and precision characteristics remains unexplored.

A number of approaches to data extraction from Web sources, commonly referred to as wrappers, have been proposed. Among them, learning-based extraction techniques are becoming important since they need relatively little user intervention. Specifically, users supply only examples of relevant data to be extracted from the sources. The process of supplying examples has been termed “labeling”. Based on the examples, an extraction algorithm automatically “learns” how to extract relevant data from the Web pages. However, as compared to a keyword search, these methods still need a relatively large amount of user input.

The notion of precision and recall in wrapper building arises as a grammar inference problem. This problem was first addressed in the works of Gold and Angluin. Gold showed that the problem of inferring a DFA of minimum size from positive examples is NP-complete. Angluin showed that the problem of learning a regular expression of minimum size from positive and negative examples is NP-complete. Both Gold and Augluin impose constraints on the size of the PAEs learned.

Angluin studied the problem of inductive inference of an indexed family of nonempty recursive formal languages from positive examples only. In this work a learner is presented a sequence of positive examples, which form some arbitrary enumeration of all the elements of the language to be inferred.

Angluin also proposed a polynomial time algorithm for actively learning the minimum DFA of a regular language from a teacher who knows the true identity of this regular language, which is an active learning framework.

The problems of learning consistent PAEs and unambiguous sets of PAEs do not have equivalent counterparts in the classical works on grammar inference and hence none of the known results are applicable.

There is a large body of work on learning subsequences and supersequences from a set of strings. The following problems are all NP-complete: (1) finding the SCS/LCS of an arbitrary number of strings over a binary alphabet; (2) finding a sequence that is a common subsequence/supersequence of a set of positive examples but not a subsequence/supersequence of any string in a set of negative examples. The semantics of PAEs differs substantially from string matching and hence their results are not applicable.

Research on wrapper construction for Web sources has made a transition from its early focus on manual and semi-automatic approaches to fully automated techniques based on machine learning. But the notion of ascribing a precision/recall metric to the learning of extraction expressions and its impact on algorithmic efficiency has not been explored in these works.

Works on learning the schema of template-driven Web documents teach that a collection of pages, generated from the same template, is required to learn the schema. The learned schema is represented as a union-free regular expression. But a sophisticated algorithm for discovering a desirable schema can suffer from exponential blow-up.

Ambiguity appears to be an implicit theme underlying the problems studied in prior works.

The works of Callan and Mitamura teach methods for learning document-specific rules for extracting data from individual Web pages. The domain knowledge is used only for validating the effectiveness of different path strings. Further, only the extraction of single-attribute data is considered.

Therefore, a need exists for a system and method for ontology-based data extraction.

### SUMMARY OF THE INVENTION

According to an embodiment of the present invention, a method for extracting an attribute occurrence from template generated semi-structured document comprising multi-attribute data records comprises identifying a first set of attribute occurrences in the template generated semi-structured document using an ontology. The method further comprises determining a boundary of each multi-attribute data record in the template generated semi-structured document, learning a pattern for an attribute corresponding to an identified attribute occurrence of the first set in the template generated semi-structured document, and applying the pattern within the boundary of each multi-attribute data record in the template generated semi-structured document to extract a second set of attribute occurrences.

The method comprises providing a seed ontology prior to identifying the first set of attribute occurrences.

The ontology is one of a seed ontology and an enriched ontology.

The method further comprises enriching the ontology with the second set of attributes occurrences.

The pattern is a path abstraction expression, wherein the path abstraction expression is a regular expression that does not comprise a union operator, and a closure operator only applies to single symbols.

Learning the pattern for each attribute occurrence comprises identifying the attribute occurrence in a data structure tree, and determining the pattern of the attribute occurrence in the data structure tree. The method further comprises generalizing the pattern of the attribute occurrence prior to applying the pattern. The pattern comprises elements including a location and a format of the attribute occurrence. The elements are nodes in the data structure tree. The method comprises resolving the ambiguities in the extracted attribute occurrences comprising identifying attribute occurrences in the template generated semi-structured document matching more than one pattern, determining a pattern that uniquely matches a given attribute occurrence and no other pattern uniquely matches the given attribute occurrence, and eliminating matches between the given attribute occurrence and another pattern that matches the given attribute occurrence and at least one other attribute occurrence.

Learning the pattern for an attribute corresponding to an identified attribute occurrence of the first set in the template generated semi-structured document comprises learning positive examples of the attribute, and learning negative examples of the attribute.

Learning the pattern for an attribute corresponding to an identified attribute occurrence of the first set in the template generated semi-structured document comprises determining a common supersequence for identified attribute occurrences corresponding to the attribute, wherein identified attribute occurrences are positive examples of the attribute, determining a generalized supersequence by generalizing each term in the common supersequence, and determining, for each term of the generalized supersequence, whether a term can be de-generalized.

Learning the pattern for an attribute corresponding to an identified attribute occurrence of the first set in the template generated semi-structured document comprises learning negative examples of the attribute, wherein the negative examples are positive examples of other attributes.

Determining the boundary of each multi-attribute data record comprises providing a tree of a page and a set of attribute names of a concept of the ontology, marking a node in the tree by a set of attributes present in a subtree rooted at the node, determining a set of maximally marked nodes in the tree, determining a page type, and extracting a boundary according to the page type. The page type is one of a home page and a referral page. Extracting the boundary further comprises determining a maximally marked node with a highest score among the set of maximally marked nodes in the tree, determining whether the tree comprises a single-valued attribute, determining values of the single-marked attribute upon determining the single-valued attribute, determining whether the tree comprises a multiple-valued attribute, and determining values of the multiple-marked attribute upon determining the multiple-valued attribute.

According to an embodiment of the present invention a method for enriching an adaptive search engine comprises providing one of a seed ontology and an enriched ontology, the ontology comprising a set of concepts and a set of attributes associated with every concept, determining an attribute identifier for a document of interest, and adding the attribute identifier to the ontology for identifying attribute occurrences in at least the document of interest.

Determining the attribute identifier further comprises determining a methodology of the attribute identifier, and determining a set of parameter values to be used by the methodology.

According to an embodiment of the present invention, a program storage device is provided readable by machine, tangibly embodying a program of instructions automatically executable by the machine to perform method steps for extracting an attribute occurrence from template generated semi-structured document comprising multi-attribute data records. The method steps comprising identifying a first set of attribute occurrences in the template generated semi-structured document using an ontology, and determining a boundary of each multi-attribute data record in the template generated semi-structured document. The method further comprises learning a pattern for an attribute corresponding to an identified attribute occurrence of the first set in the template generated semi-structured document, and applying the pattern within the boundary of each multi-attribute data record in the template generated semi-structured document to extract a second set of attribute occurrences.

According to an embodiment of the present invention, an adaptive search engine appliance for searching a database of multi-attribute data records in a template generated semi-structured document comprises an ontology for identifying a first set of attribute occurrences in the template generated semi-structured document, the ontology comprising a set of concepts and a set of attributes associated with every concept. The adaptive search engine further comprises a boundary module for determining a boundary of each multi-attribute data record in the template generated semi-structured document, and a pattern module for learning a pattern for an attribute corresponding to an identified attribute occurrence of the first set in the template generated semi-structured document, wherein the pattern is applied within the boundary of each multi-attribute data record in the template generated semi-structured document to extract a second set of attribute occurrences. The database of multi-attribute data records is stored on a server connected to the adaptive search engine application across a communications network.

### BRIEF DESCRIPTION OF THE DRAWINGS

Preferred embodiments of the present invention will be described below in more detail, with reference to the accompanying drawings:

FIG. 1 is an illustration of a Wed page;

FIG. 2 is an illustration of a Web page;

FIG. 3 is a diagram of a document object model tree of the data shown in FIG. 2 according to an embodiment of the present invention;

FIG. 4 is an illustration of an ontology of FIG. 2 according to an embodiment of the present invention;

FIG. 5 is a diagram of a system according to an embodiment of the present invention;

FIGS. 6a, 6b, and 6c are illustrations of bipartite resolution according to an embodiment of the present invention;

FIGS. 7a and 7b show extraction results according to an embodiment of the present invention;

FIGS. 8a and 8b show extraction results for consistent PAEs according to an embodiment of the present invention;

FIGS. 9a and 9b show extraction results according to an embodiment of the present invention; and

FIG. 10 is a diagram of a system according to an embodiment of the present invention.

### DETAILED DESCRIPTION OF PREFERRED EMBODIMENTS

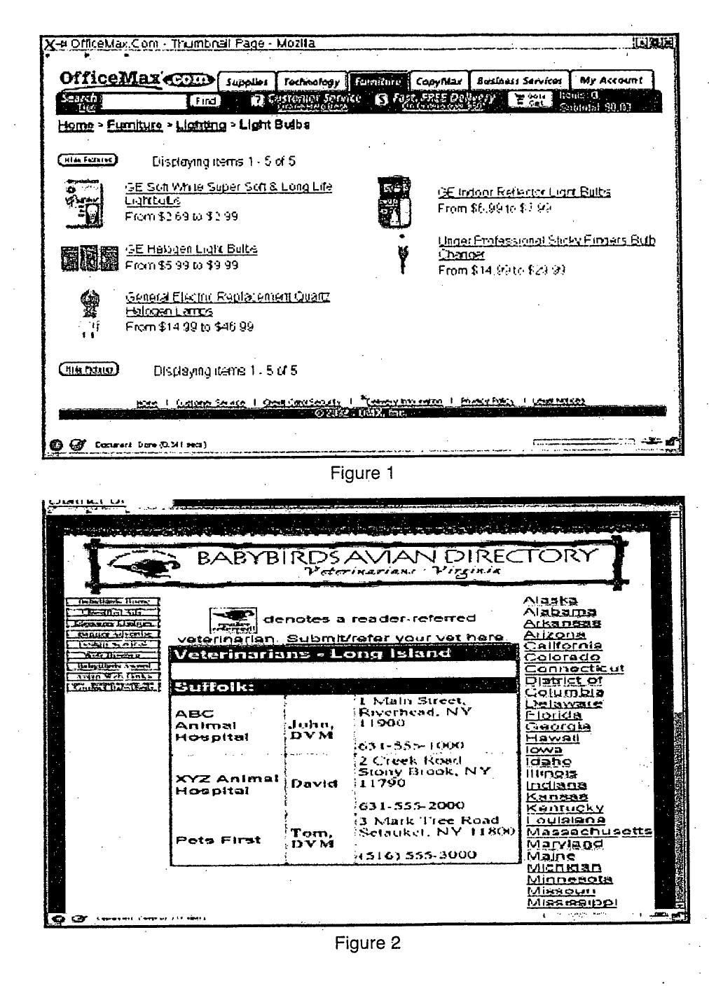

Numerous Web data sources comprise database-like information about entities and their attributes. FIGS. 1 and 2 exemplify typical Web data sources. For example, each product in FIG. 1 and each veterinarian service provider in FIG. 2 is an entity. Web pages comprising entity information are typically generated from templates to reduce the overhead associated with generating the Web pages.

According to an embodiment of the present invention, aggregating data from such sources into a queriable database enables end users to search for information, such as locating a specific product or service of interest, quickly and easily. There are several product and service provider entities shown in FIGS. 1 and 2, each entity corresponding to a set of attributes. An attribute is characterized by a name and a domain from which its values are drawn. For example, the attributes associated with a veterinarian entity in FIG. 2 are: name, address, and telephone number of the service, and the name of the veterinarian providing the service. Their value domains are all strings.

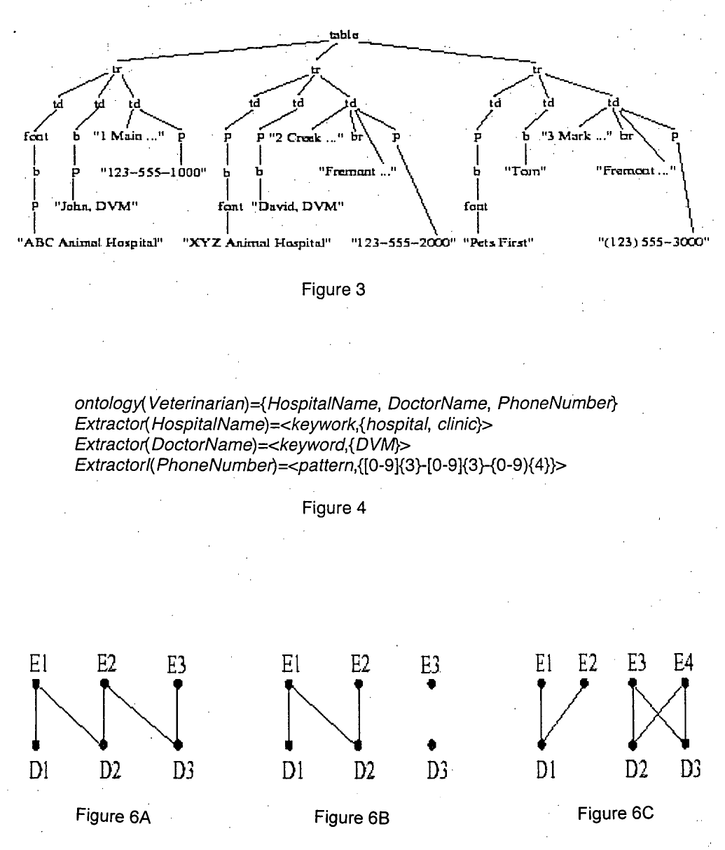

Among the important aspects in data aggregation is the idea that the boundaries of entities in the source need to be identified. The boundaries define blocks or regions in the source, each block encapsulating all of the attributes of an entity. Within a Web page a block corresponds to a subtree in its DOM (Document Object Model) tree and all the attributes adorning the leaf nodes of such a subtree belong to a single entity. For example in FIG. 3, which is a fragment of the DOM tree for the Web page shown in FIG. 2, each subtree rooted under each tr node is a block corresponding to a veterinarian entity. The problem of locating such entity blocks can be called marking and scoring. For example, the problem can be formulated as one of detecting record boundaries.

The concept of an ontology is important to the formalization of a service directory. A concept in an ontology is a type of service, e.g., Veterinarian. The ontology associates attributes with service providers, e.g., service provider's name, address, phone, email, vet's name etc. Some of them may be shared across different service domains, e.g., address, phone, email, etc. A member of a concept is denoted as an entity. Attributes are associated with an entity. The attributes of an entity can be single and multi-valued. A single-valued attribute means that the entity can have at most one value whereas it can have several values for multi-valued attributes.

An ontology can be defined as a 10-tuple
O=<C, T, D, Aₘ, Aₙ, τ, Valₛ, Valₘ, Attr_extractor>
where:
C is a set of service concepts.
T⊂C×C is the taxonomy and denotes the IS-A relationship between concepts.
D is the set of domain types. A domain type can be the set of all strings, set of all integers, etc.
Aₛ is the set of single-valued attribute names while Aₘ is a set of multi-valued attribute names.
A: C→2^{_{A}}^{∪A}^{ₛ} is a function that associates a set of attributes with a concept.
τ: Aₘ∪Aₛ→D is a function that associates a domain type to every attribute.
valₛ: Aₛ→(C→τ(Aₛ)) is a function denoting that the attributes in Aₛ are single-valued.
valₘ: Aₘ→(C→2^{τ(A}^{ₘ}⁾) is a function denoting that the attributes Aₘ can take multiple values.
Attr_extractor: Attr→(string→2^{τ(Attr)}), Attr∈(Aₘ∪Aₙ).

All these pages are assumed to be HTML pages.

Each entity is uniquely identified by a set of single-valued attributes. Any such set can be called a key, e.g., for service providers two possible keys are {street, city} and {street, zip}. The attributes in a home page are associated with a single entity whereas a referral page comprises several entities.

Let [symbol] denote the bag union of a set of elements. In such a union elements can repeat.

A consistent bag can be written as: Let S be a bag comprising of pairs of the form <Aᵢ,Xᵢ> wherein Aᵢ is an attribute and Xᵢ is a set of values. S is consistent iff, ∀<Aᵢ, Xᵢ>, <Aⱼ, Xⱼ> if Aᵢ, Aⱼ∈Aₛ then Aᵢ≠Aⱼ.

Let T be the DOM tree of a page. The leaf nodes in T are text strings. Parent(n) denotes the parent of node n and denotes all its children. To identify subtrees in T in which no single-valued attribute occurs more than once, the notion of a mark can be used. c refers to a particular concept in C.

A mark can be written as: Let n be a node in T.

$${mark}_{c} ( n ) \{ \begin{matrix} if n is a leaf = \{ \begin{matrix}\{ < {A}_{i} , Attr\_identifier ( {A}_{i} ) ( σ ) > \vert & {A}_{i} ∈ A ( c ) \\ & ⩓ σ is the text string associated with n \\ & ⩓ {A}_{i} ∈ {A}_{s} -> \vert Attr\_identifier ( {A}_{i} ) ( σ ) \vert \leq 1 \} \\ ϕ , & else\end{matrix} \\ if n is not a leaf = \{ \begin{matrix}{⋃}_{m ∈ children ( n )} {mark}_{c} ( m ) , & {m ∈ children ( n )}_{} {mark}_{c} ( m ) is consistent \\ ϕ , & {m ∈ children ( n )}_{} {mark}_{c} ( m ) is not consistent\end{matrix}\end{matrix}$$

Whenever mark(n) is φ it means that there exists more than one occurrence of a single valued attribute in its subtree. The definition also suggests how to propagate marks. Specifically, the subtrees rooted at a node can be merged as long as no single-valued attribute occurs in more than one subtree.

For notational simplicity, mark(n) is used in place of mark_{c}(n) whenever c is known from the context. To associate attributes with entities the notion of a maximally marked node.

The maximally marked node can be written as: Let n be an internal node.

$$maximal ( n ) = \{ \begin{matrix}true , & n is not leaf ⩓ mark ( n ) \neq ϕ ⩓ mark ( parent ( n ) ) = ϕ \\ false , & otherwise\end{matrix}$$

Maximally marked nodes are marked as ≠φ while their parent, node 1, is marked φ. Intuitively, the leafs of a maximally marked node are the attributes of a single entity.

The method for extracting attribute values from a page is now described. Let σ(n) denote the concatenation of the text strings associated with the leaf nodes of the subtree rooted at n,Attr be the set of attributes of the concept c, {k₁, . . . , kₙ} be the attributes that comprise the key of c; and R(a₁, . . . , aₙ), denote the tuple of attributes associated with an entity. One tuple is extracted from a home page and several such tuples from a referral page.

score(n) denotes |mark(n)|.

```
Algorithm Extract (T, Attr)
begin
1. forall nodes n ∈ T do
2. mark(n)
3. end
4. Let Γ = { maximally marked nodes in T } ∪
    {all leaf nodes marked φ }
5. if ∃mᵢ, mⱼ ∈ Γ Λ {Attr_identifier(kₗ)(σ(mᵢ)), ..., Attr_identifier(kₙ)
    (σ(mᵢ))
    {Attr_identifier(kₗ)(σ(mⱼ)), ..., Attr_identifier(kₙ)(σ(mⱼ))}
    then
6. T is a referral page
7. else
8. T is a home page
9. endif
10. if T is a home page then
11.  R = Extract_Home_Page(Attr, Γ)
12. elseif T is a referral page then
13.  {R₁, ..., Rₙ} = Extract_Referral_Page(Attr, Γ)
14. end
end
```

The extraction method Extract takes as input the tree of the page and the set of attributes names of the concept c. It outputs either a single tuple containing the values of the attributes if it is a home page or a set of tuples if it is a referral page. In lines 1-3, every node in the tree is marked by the attributes present in the subtree rooted at the node. In line 4, the set of maximally marked nodes in the tree is determined. Line 5 tests for a home page or a referral page. Specifically the nodes in Γ cannot have different key values; otherwise it is a referral page. Depending on the type of page the appropriate algorithm is invoked (lines 10-14). The extraction method from home pages is described below.

Algorithm Extract_Home_Page (Attr, Γ)
begin
1. pick the node n in Γ with the maximum score
2. forall aᵢ ∈ Attr Λ aᵢ ∈ A₈ do
3. R[aᵢ] = Attr_identifier(aᵢ)(σ(n))
4. end
5. forall aᵢ ∈ Attr Λ aᵢ ∈ Aₘ do
6. R[aᵢ] = ∪_{m4∈Γ} Attr_identifier(aᵢ)(σ(mᵢ))
7. end
8. return R
end

Extract_Home_Page takes as input the set of attribute names whose values are to be extracted and the set of maximally marked nodes in the document tree. In line 1, the maximally marked node with the highest score is determined. The values of any single-valued attribute are obtained from this node. This is done in lines 2-4. Values of multi-valued attributes are obtained from all the maximally marked nodes in the tree, which is done in lines 5-7. The extracted tuple containing values of all the attributes is returned in line 8

For referral pages we have to extract the attributes of several entities. The main problem here is associating the extracted attributes with their corresponding entities. The notion of a conflicting set can be used in making such an association.

Let Γ be as defined for the extraction method. Observe that whenever Γ is an ordered set of nodes. Let <m₁, mₛ, . . . , m_{q}> denote the nodes in this ordered sequence. Γ is conflict-free whenever ∃i,mᵢ,mᵢ₊₁∈Γ such that mark(mᵢ) [symbol] mark(mᵢ₊₁) is consistent. Γ is not conflict-free if all pairs of consecutive nodes are mutually inconsistent.

Whenever Γ is not con ict-free then any maximally marked node represents a single entity. All we need to do is simply pick the attributes in it and create the tuple for that entity (e.g., line 7 in Extract_Referral_Page method). If this is not the case then attributes of an entity may be spread across neighboring nodes. In that case we will have to detect the boundaries separating each entity (line 12). In addition even if Γ is con ict-free the leaf nodes in it will have conicts and boundaries separating the attributes of entities will need to be detected in the text string at the leaf node (line 4).

Boundary detection partitions the attribute occurrences and link them with the proper entities.

Algorithm Extract_Referral_Page (Attr, Γ)
begin
1. if Γ is not conflict-free then
2. forall mᵢ ∈ Γ do
3. if mᵢ is a leaf Λmark(mᵢ) = φ then
4. {R₁, ..., Rₙ} = Boundary_Detection(Attr, mᵢ)
5. else
6. forall aⱼ ∈ Attr do
7. Rᵢ[aⱼ] = Attr_identifier(aᵢ)(σ(mᵢ))
8. end
9. end
10. end
11. else
12. {R₁, ..., Rₙ} = Boundary_Detection(Attr, Γ)
13. end
14. return {R₁, ..., Rₙ}
end

In the absence of well-defined boundaries between entities, the sequence of attribute occurrences need to be separated into maximal partitions. A partition is a sequence of attribute occurrences such that any single-valued attribute occurs at most once in it whereas multi-valued attributes can have many occurrences, provided all such occurrences are consecutive. In a maximal partition adding an attribute will violate the above definition of a partition. According to an embodiment of the present invention, an algorithm for boundary detection greedily discovers maximal partitions. Attributes are picked one by one from the sequence. It is determined whether it can be added to the current partition. If it cannot be added then the current partition is maximal and new partition if begun with this element.

The boundary detection described herein can be replaced by more complex boundary detection method that take into account the regularity in the entire sequence of attribute occurrences. Such algorithms need to keep track of a history of an order, based on the positions of the attribute occurrences in the sequence, which exists between the attributes.

For the extraction of attributes with unbounded domains it can be difficult to specify robust extractor functions for attributes with unbounded domains (e.g., names of doctors, hospitals, hotels, etc.) or when they are misspelled. For example, Lakes Aminal Clinc, hrs., (1222) 223-3456 instead of Lakes Animal Clinic, hours, (122) 223-3456. To identify them in the document, recall that the attributes of service entities in a referral page exhibit “regularity”. For example, the name of the hospital may always be in the first column and the name of the doctor in the second column of a table for a particular referral page. An unsupervised learning technique that exploits this regularity in a referral page can identify attributes missed by the extractor functions.

Suppose that some occurrences of an attribute, e.g., hospital name, have been identified in the trees rooted at maximally marked nodes. The indexed paths serve as the positive examples for the learning method. According to an embodiment of the present invention, a learning method proceeds as follows: determine a generalized path expression from the longest common subsequence (lcs) of these path strings. In finding the lcs, ignore the indices of the tags in the path strings and turn the paths into sequence of tags. Since the tags in the lcs appears in each of these strings there exists an association from every tag in the lcs with a corresponding tag in every other path, e.g., for the above example the lcs would be tr,td,h1,font,text. A generalized path expression Ω is learned from the lcs as follows: transform the lcs into lcs′. For every tag in the lcs, if the tag has an index and the indices of all the corresponding tags in the path strings are the same then retain this tag along with its index in lcs′ otherwise retain only the tag without its index, e.g., for the above lcs, the lcs′ would be tr,td[1],h1,font [1], text. Now we construct Ω, the generalized path expression for a marked instance, e.g., hospital name, from lcs′. Let P denote the set of path strings from which the lcs was constructed. Let α₁; α₂, . . . αₖ be the elements in lcs′. Suppose γᵣ and γₛ are the elements of a path string in P that correspond to αᵢ and αᵢ₊₁ respectively. If γᵣ and γₛ are not consecutive in any path string then add ‘\\’ in between αᵢ and αᵢ₊₁ in Ω. The ‘\\’ operator means that after αᵢ searching for αᵢ₊₁ appears in the subtree rooted in αᵢ. Otherwise, add a ‘\’ operator in between αᵢ and αᵢ₊₁ in Ω, e.g., Ω=\tr\td[1]\h1\\font [1]\text ( ).

The paths that will be matching instances of Ω from maximal nodes will include all the path strings in P as well as some other paths. The missing attributes may occur on the leafs of these other paths. But it may also include certain unwanted attributes. The paths to such attributes will form the negative examples N to the learning method. Ω is specialized to Ωₛ by identifying and adding an HTML attribute-value pair, such as color=“#FF0000”, that will eliminate the path strings in the negative set from becoming instances of Ωₛ and still retain all the positive instances, e.g., Ω=\tr\td[1]\h1\\font[1]@[color=“#FF0000”]\text( ). If the method is unable to find such an attribute-value pair in P∪N then the learning method would fail meaning that no regularity exists for this attribute in the referral page.

Given the methods for boundary detection above and those methods known in the art, for purposes of the disclosure, it is assumed that the entity blocks in the source have all been identified.

Another important aspect in data aggregation is data extraction, e.g., locating data values in an entity block and correctly associating the data values with the attributes of the entity. For example, data extraction on the block rooted under the tr 301 in FIG. 3 amounts to locating the values, “ABC Animal Hospital”, “John, DVM”, and “123-555-1000”, and associating the values with the attributes, Hospital Name, Doctor Name, and Phone Number, respectively.

According to an embodiment of the present invention, manual labeling of data to be extracted can be avoided and automation can be enhanced by using an ontology for labeling.

An ontology comprises a set of concepts and a set of attributes associated with every concept that is appropriate to describe the concept. FIG. 4 illustrates an ontology for veterinarians. For example, the concept “veterinarian service provider” has three attributes, namely, the name, and phone number of the veterinarian service provider, and the name of the veterinarian affiliated with the service. An instance of this concept is the object comprising attributes, “ABC Animal Hospital”, “123-555-1000”, and “John, DVM” as shown in FIG. 3.

An ontology can also be enriched with an attribute identifier function for each attribute. Applying an identifier function to a Web page will locate all the occurrences of the attribute in that page. An identifier function is represented as a pair of elements, where a first element denotes the kind of methodology that is used to locate the data values for the attribute, and a second element is an enumerated set of parameter values that are used by the specific methodology. For example, in FIG. 4 “keyword” denotes keyword-based search methods while “pattern” refers to pattern matching methods. Note that the identifier function for the PhoneNumber attribute (denote Extractor(PhoneNumber)) in FIG. 4 is specified by the regular expression (in Perl programming syntax), [0-9]{3}-[0-9]{3}-[0-9]{4}, which encodes a pattern for matching phone numbers. This expression will locate two telephone numbers in FIG. 2.

Observe from the example above that an ontology encodes knowledge about an application domain, e.g., veterinarians. Hence, once an ontology is built for a specific domain it can be deployed for extraction from any source comprising data relevant to that domain. Furthermore, since no assumptions are made about a data source, the ontology can be used even if the source is modified. So ontology-based extraction techniques using learning are highly automated, scalable, and resilient to changes in data source structures.

According to an embodiment of the present invention, ontology-based data extraction comprises parsing each Web page into a DOM tree and applying the identifier functions to locate occurrences of attributes in the page.

Identifier functions may not be “complete” in the sense that they cannot always locate all the attributes in a page, for example, when the domain of an attribute is not completely known. FIG. 2 illustrates a case where an identifier function that depends on determining the keyword “hospital” in a provider's name would have located “ABC Animal Hospital” and “XYZ Animal Hospital” but not “Pets First”.

According to an embodiment of the present invention, the attribute occurrences located by the identifier functions as examples for learning path queries to pull out the missing occurrences. Path queries, or Path Abstraction Expressions (PAEs), are implemented as a class of regular expressions using the concatenation (“•”) and the Kleene closure (“*”) operators. For example, in FIG. 2 the extractor function for the veterinarian hospital name attribute has denitrified the two occurrences “ABC Animal Hospital” and “XYZ Animal Hospital”. In the DOM tree (see FIG. 3) the paths leading to the leaf nodes, which comprise these text strings are α table·tr·td·font·b·p and α table·tr·td·p·b·font, respectively, where α represents the path string from the root of the document to the table tag. A PAE, E₁=α table·tr·td·font*·p*·b·p*·font*, can be learned from these two paths. Observe that if the PAE is used as a path query that is evaluated against the DOM tree, it should return the text string “Pets First”. A PAE is learned for each attribute from the corresponding path strings of the attribute's occurrences that were identified by the extraction function, e.g., the two path strings above. The PAE is used for extracting the remaining occurrences of the attribute that were missed by the identifier function, “Pets First” in the above example.

However, the language of E₁, i.e., the set of path strings that are accepted by E₁, also comprises the path string, α·table·tr·td·p·b, which is a path in the DOM tree leading to the text string “David, DVM”. But this is an occurrence of a different attribute in the schema, namely the name of the veterinarian doctor. The reason is that the PAE learned is overly general. By extracting false positives, such as the veterinarian's name in the preceding example, the approach for increasing recall by learning extraction expressions can reduce precision, which is a measure of the accuracy of the extracted data. Even in learning systems where the user manually labels the examples, the extracted data can still suffer a loss of precision. According to an embodiment of the present invention, a data extraction method improves recall while maintaining a high level of precision.

According to an embodiment of the present invention, different PAEs can be learned from the same set of examples. For example, another PAE, E₂=α·table·tr·td·p*·b*·font·b*·p*, can be learned from α·table·tr·td·font·b·p and α·table·tr·td·p·b·font. Notice that the language of PAE E₂ will not include the path string α·table·tr·td·p·b. In fact none of the path strings corresponding to the attribute DoctorName will be in E₂'s language. Thus, E₂ retains more precision than E₁.

Therefore, based on the extent to which false positives can be excluded from a PAE's language, a quality is ascribed to each PAE learned. To learn a PAE for an attribute A from a set of examples, the set of all the path strings corresponding to A's occurrences that have been identified by A's identifier function constitute its positive examples, while all the occurrences extracted by the identifier functions of other attributes serve as its negative examples. For example, to learn a PAE for pulling out names of veterinarian hospitals in FIG. 3, the paths to “ABC Animal Hospital” and “XYZ Animal Hospital” serve as the positive examples, whereas the paths to the occurrences of the other two attributes identified by their corresponding identifier functions, namely the doctor names, “John, DVM” and “David, DVM”, and the phone numbers, “123-555-1000” and “123-555-2000”, serve as the negative examples. Different classes of PAEs are formulated with increasing degrees of quality.

A variety of extraction methods can be learned, each exhibiting different recall and precision characteristics.

A polynomial time method for learning nonredundant PAEs is one example. The language of a nonredundant PAE includes all of its positive examples. Removing any symbol from a nonredundant PAE will result in excluding one or more of the positive examples from its language.

Another method comprises heuristics for learning unambiguous PAEs from a set of examples. The language of a nonredundant PAE may include negative examples and hence can suffer loss of precision. Consistent PAEs can be used to improve precision. The language of a consistent PAE comprises all the positive examples while excluding all the negative ones. Typically, an entity has more than one attribute. To handle such multi-attribute entities a set of PAEs are learned, one per attribute. When the PAEs for the attributes are all consistent this set of PAEs is said to be unambiguous with respect to the examples. The problem of learning a set of PAEs that is unambiguous with respect to a given set of examples is NP-complete.

Note that the above notion of unambiguity is relative to a given set of examples. When a set of PAEs is unambiguous with respect to any example set it can be said that it is inherently ambiguous. Such a set of PAEs will suffer the least loss of precision in extraction. According to an embodiment of the present invention, the problem of learning an inherently unambiguous set of PAEs is decidable.

Note that when using a set of nonredundant PAEs for extracting the attribute values of multi-attribute entities, ambiguities can occur resulting in loss of precision. Moreover, because learning an unambiguous set of PAEs is computationally difficult, heuristics need to be used. Since these heuristics may not guarantee that all of the PAEs learned are consistent, ambiguities can still occur when using such sets of PAEs for extracting attribute values of multi-attribute entities. According to an embodiment of the present invention, ambiguity resolution is modeled as an algorithmic problem over bipartite graphs. By combining knowledge about the attribute domains encoded in the ontology with this method, the ambiguities are resolved thereby improving recall without much loss in precision.

Experimental evidence of the effectiveness and efficiency of the learning methods for improving recall without compromising on precision. Specifically, attribute data was extracted from over 200 different Web pages listing veterinarian service providers and products. The results, obtained from running these methods over these pages, indicate that the overall recall achieved ranges from 58% to 100% with substantially no loss in precision.

The extraction methods can also be applied to pages comprising attribute data for single entities only, such as a page exclusively describing the attributes and features of one product only. All such pages will have similar structural characteristics when they are machine-generated from templates. For learning in such cases examples from different pages corresponding to entities having the same set of attributes can be provided.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

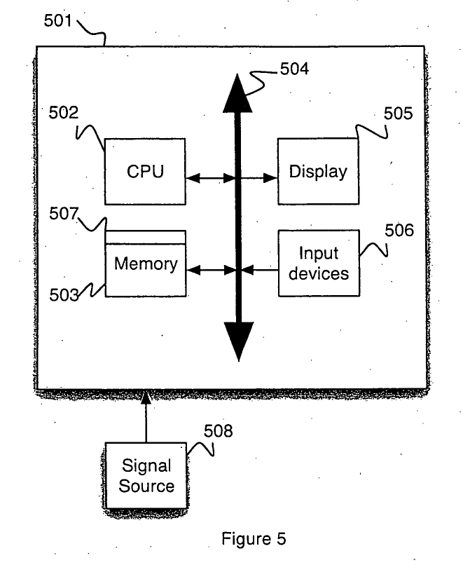

Referring to FIG. 5, according to an embodiment of the present invention, a computer system 501 for implementing the present invention can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 that is stored in memory 503 and executed by the CPU 502 to process the signal from the signal source 508. As such, the computer system 501 is a general purpose computer system that becomes a specific purpose computer system when executing the routine 507 of the present invention.

The computer platform 501 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

According to an embodiment of the present invention, |S| and |α| denote the cardinality of a set S and the length of a string α, respectively. A subsequence of a given string is obtained by deleting zero or more symbols from this string. The longest common subsequence (LCS) of a set of strings is a subsequence that is common to all of the strings and is the longest such subsequence. A string β is a supersequence of another string α if and only if α is a subsequence of β. The shortest common supersequence (SCS) of a set of strings is a supersequence that is common to all of the strings and is the shortest such supersequence. Both the LCS and the SCS of two strings can be computed in quadratic time.

Using the definitions for recall and precision given above, let T denote the number of actual occurrences of an attribute A in a document; T′ being the number of attribute occurrences extracted from the document, out of which T″ are actual occurrences of A. Recall for the attribute A is defined as T″/T, while precision is T″/T′. A path abstraction expression is substantially similar to a regular expression but with two restrictions: (i) it is free of the union operator (“|”); and (ii) the Kleene closure operator (“*”) can only apply to single symbols.

The following terms are defined for describing methods according to embodiments of the present invention: Path Abstraction Expression; cover; nonredundancy; consistency; unambiguity; and inherent unambiguity. The Path Abstraction Expression (PAE) can be defined by the following: Let Σ be a finite alphabet. A PAE over Σ is defined inductively as follows:
Any symbol c∈Σ is a path abstraction expression.
For any c∈Σ, c* is a path abstraction expression.
If E₁ and E₂ are path abstraction expressions, so is E₁·E₂.

For example, a·b*·c is a PAE whereas neither a·(b|c) nor a·(b·c)* is a PAE. By disallowing the union operator (“|”) in the syntax of PAEs, generalization can be enforced in the learning methods. Otherwise, a regular expression could be composed by concatenating all the input strings using the union operator. Such techniques do not capture regularity in the paths within a DOM tree.

Although the Kleene closure operator (“*”) is limited to single symbols only, this does not impose any extra technical difficulty. This simplification is enforced for the Web domain, since it is rare that a consecutive sequence of tags would repeat itself in the root-to-leaf paths of a DOM tree.

Note that a·*·c is not a PAE either, although it is a valid XPath query. In the XPath syntax “*” actually stands for the entire alphabet Σ. Because the union operator is not allowed in PAEs, XPath's Σ syntax is also not allowed. However, a query referring to can be simulated. For example, let Σ=a,b. Then the XPath query, a·*·b, can be simulated using the PAE a·a*·b*·b.

The concatenation operator (“·”) is omitted in a PAE. Given a PAE E, the set of strings recognized by E is denoted as L(E).

The term “Cover” is defined as follows: Let S be a set of strings and E be a PAE. E covers S, or E is a cover of S, if L(E) [symbol] S. Similarly, let{E₁, . . . , Eₙ} be a set of PAEs and {S₁, . . . , Sₙ} be a set of sets of strings. {E₁, . . . ,Eₙ} covers {S₁, . . . , Sₙ}, if Eᵢ covers Sᵢ for all 1≦i≦n.

For example, ab*c covers {ac,abbc} whereas ab*c does not cover {aac,abbc}, since aac∉L(ab*c). {ab*c,aa*b*c} covers {{ac,abbc},{aac,abbc}} whereas {aa*b*c,ab*c} does not cover {{ac,abbc},{aac,abbc}}, since aac∉L(ab*c).

The term “Nonredundancy” is defined as follows: Let S be a set of strings and E be a PAE that covers S. E is nonredundant with respect to S, if either of the following operations cannot be performed on E to obtain a new PAE E′ that also covers S:
Remove any symbol together with its Kleene closure operator (“*”), e.g., c*.
Remove a Kleene closure operator (“*”) from a symbol only.

Given a set of strings S, a PAE E can be learned that covers S. Intuitively, E represents a generalization of all the strings in S. However, if E over-generalizes then it will produce more false positives when E is later implemented as a query against the DOM tree. Note that if either of the two operations in the discussion of nonredundancy above can be performed on E to obtain E′ that also covers S, then L(E′)⊂L(E). Thus, E′ produces less false positives in general. In other words, E′ retains more precision than E and so has better quality. A nonredundant PAE needs to be learned to generalize a set of path strings.

For instance, let S={ab,bc}. Then a*b*c* is redundant with respect to S, since if the Kleene closure operator is removed from b, then a*bc* still covers S. Thus, a*bc* is nonredundant with respect to S. And b*c*a*b* is also nonredundant with respect to S.

Notice that nonredundant PAEs do not say anything about negative examples. When dealing with negative examples the term “Consistency” is defined as follows: Let E be a PAE, and POS and NEG be two sets of strings. E is consistent with respect to <POS;NEG>, if L(E) [symbol] POS and L(E)∩NNEG=Ø.

In the above definition of consistency, the strings in POS serve as positive examples while the strings in NEG serve as negative examples. Intuitively, if E is consistent with respect to <POS;NEG>, then E generalizes all the strings in POS but excludes all the strings in NEG. For example, the PAE aab* is consistent with respect to <{aa,aab},{ab,cd}> whereas a*b* is not consistent with respect to <{aa,aab},{tab,cd}>, since the negative example ab∈L(a*b*).

Given a pair of sets of positive and negative examples, there is not always a PAE that is consistent with respect to these examples. For example, it can be shown that there is no PAE that is consistent with respect to <{ab,cd}, {aa,aab}>.

Nonredundant PAEs do not say anything about negative examples and hence nonredundant PAE based extraction tends to have lower precision than consistent PAEs. Qualities of nonredundancy and consistency are associated with a single PAE. In practice several attributes of an entity may need to be extracted. Given an ontology with multiple attributes, the identifier functions for these attributes are able to identify several occurrences for each attribute, although they may not be complete. Thus, a set of examples for each attribute can be obtained. A PAE is learned for each attribute. Note that for any given attribute, the positive examples from other attributes will serve as negative examples for this attribute. Thus, two different degrees of quality can be assigned to learning a set of PAEs from a set of sets of examples. If for any given attribute, a consistent PAE is learned that covers the positive examples of this attribute but excludes all the positive examples of other attributes, then this set of PAEs is unambiguous with respect to the given set of sets of examples.

“Unambiguity” is defined by the following: Given a set of sets of strings, {S₁, . . . , Sₙ} and a set of PAEs, {E₁, . . . , Eₙ}, {E₁, . . . , Eₙ} is unambiguous with respect to {S₁, . . . , Sₙ}, if Eᵢ is consistent with respect to <Sᵢ,∪_{j≠i}Sⱼ> for all 1≦i≦n.

However, even when a set of PAEs is unambiguous with respect to the examples, the languages recognized by these PAEs may still overlap. When some or all of these languages overlap, ambiguity may arise when these expressions are executed as queries against the DOM tree, since they may identify the same text string. One option for eliminating the ambiguity is to specify that these languages be pair wise disjoint. Assuming parities disjoint languages, the set of PAEs is inherently unambiguous. Inherently unambiguous PAEs are able to retain more precision than those that are only unambiguous with respect to the given examples. This idea is formalized in the following definition.

The term “Inherent Unambiguity” is defined as follows: Let {S₁, . . . , Sₙ} be a set of sets of strings and {E₁, . . . , Eₙ} be a set of PAEs. {E₁, . . . , Eₙ} is inherently unambiguous with respect to {S₁, . . . , Sₙ}, if {E₁, . . . , Eₙ} covers {S₁, . . . , Sₙ} and L(Eᵢ)∩L(Eⱼ)=Ø; for all 1≦i≦n, 1≦j≦n, and i≠j.

For example, {ab*c,abc*} is unambiguous with respect to the examples {{ac,aabc},{ab,abcc}}, but not inherently unambiguous, because abc∈L(ab*c) and abc∈L(abc*). As another example, {ab*c,abc*d} is inherently unambiguous with respect to {{ac,abbc}, {abd,abccd}}.

Given a pair of sets of examples, is there a pair of PAEs that is inherently unambiguous with respect to these examples. For example, as shown above, {ab*c,abc*} is unambiguous with respect to {{ac,aabc},{ab,abcc}}. It can also be shown that there is no pair of PAEs that is inherently unambiguous with respect to {{ac,abbc}, {ab,abcc}}.

According to an embodiment of the present invention, a method solves a different problem for each type of PAE, e.g., consistent PAEs, unambiguous PAEs, and inherently unambiguous PAEs.

For consistent PAEs, given two sets of strings POS and NEG, the method determines whether there is a PAE that is consistent with respect to <POS;NEG>.

For unambiguous PAEs, a method, given a set of sets of strings, {S₁, . . . , Sₙ}, determines whether there is a set of PAEs, {E₁, . . . , Eₙ}, such that {E₁, . . . , Eₙ} is unambiguous with respect to {S₁, . . . , Sₙ}.

For inherently unambiguous PAEs, given a set of sets of strings, {S₁, . . . , Sₙ} a method determines whether there is a set of PAEs, {E₁, . . . , Eₙ}, such that {E₁, . . . , Eₙ} is inherently unambiguous with respect to {S₁, . . . , Sₙ}. Each of these problems is described in more detail below.

The above three problems are not equivalent problems. Let <S₁, S₂> be a pair of sets of strings. The existence of a PAE that is consistent with respect to <S₁, S₂> does not necessarily imply that there is a pair of PAEs that is unambiguous with respect to {S₁, S₂}. Similarly, the existence of a pair of PAEs that is unambiguous with respect to {S₁, S₂} does not necessarily imply that there is a pair of PAEs that is inherently unambiguous with respect to {S₁, S₂}.

For example, aab* is consistent with respect to <{aa,aab},{ab,cd}>. But there is no pair of PAEs that is unambiguous with respect to {{aa,aab},{ab,cd}}. Similarly, {ab*c,abc*} is unambiguous with respect to {{ac,abbc},{ab,abcc}}. But there is no pair of PAEs that is inherently unambiguous with respect to {{ac,abbc},{ab,abcc}}.

According to an embodiment of the present invention, nonredundant PAEs can be learned. A method for learning nonredeundant PAEs is exemplified by the algorithm LearnPAE, which takes as input a set of positive examples of an attribute (S+) and returns as output a nonredundant PAE (E) that covers this set of positive examples.

```
LearnPAE (S+)
input
    S+: a nonempty set of strings
output
    E: a nonredundant PAE which covers S+
begin
1. n=|S+|
2. Let αᵢ(1≦i≦n) be a string in S+.
3. E=αᵢ
4. for 2≦i≦n do
5. E=SCS(E, αᵢ)
6. endfor
7. Put a * on all the symbols of E.
8. E = MakeNonredundant (E,S+)
9. return E
end
```

In Line 3, the variable E is initialized with the first positive example. In Lines 4-6, the shortest common supersequence (SCS) of the string stored in E and the next positive example is determined and assigned to E. When the loop in Lines 4-6 terminates, E stores a common supersequence for all the strings in S+. In Line 7, the string stored in E is generalized to a PAE that covers S+ by adding * on all the symbols in E. The operation increases the language accepted by the PAE. Intuitively, this corresponds to a generalization beyond the identified positive examples.

The procedure MakeNonredundant takes as input a PAE, E, and a set, S+, of positive examples that is covered by E. When the procedure ends, it makes E nonredundant with respect to S+. That is, for every symbol in E that comprises a * it is determined whether by dropping the symbol along with the * from E the resulting PAE still covers S+. If the resulting PAE covers S+, the symbol together with the * is dropped from E (Lines 4-7). If not, then it is determined whether the PAE obtained by dropping only the * on the symbol still covers S+. If the resulting PAE covers S+, then the * is dropped from the symbol (Lines 9-10).

MakeNonredundant(E,S+)
input
E: a PAE which covers S+
S+: a nonempty set of strings
output
Q: a nonredundant PAE which covers S+
begin
1. n=the number of symbols in E excluding *
2. Let χᵢ (1≦i≦n) be the i-th symbol in E.
3. for 1≦i≦n do
4. if a * is attached to χᵢ then
5. R= drop χᵢ together with its * from E
6. if R covers S+ then
7. E=R
8. else
9. R= drop the * that is attached to χᵢ from E
10. if R covers S+ then E=R endif
11. endif
12. endif
13. endfor
14. Q=E
15. return Q
end

Note that if either of the two operations on Lines 4-7 and Lines 9-10 succeeds, then the language recognized by the new PAE is strictly smaller than that of the old PAE. The procedure MakeNonredundant returns a PAE, Q, which is nonredundant with respect to S+. Moreover, the complexity of the algorithm LearnPAE is polynomial time.

For illustration, the ontology in FIG. 4 identifies the attribute values “ABC Animal Hospital” and “XYZ Animal Hospital” in FIG. 3. Invoking the method LearnPAE with their path strings, table·tr·td·font·b·p and table·tr·td·p·b·font, results in determining table·tr·td·font·p·b·p·font as the SCS on exiting the for-loop in Lines 4-6 of the LearnPAE method. Then MakeNonredundant is invoked in Line 8 with table*·tr*·td*·font*·p*·b*·p*·font* as its input and the procedure returns table·tr·td·font*·p*·b·p*·font* as its output, which is the nonredundant PAE learned for extracting the HospitalName attribute. This PAE will also extract “Pets First” which was missed by the ontology described above.

Regarding a method for learning consistent PAEs, since the method LearnPAE only takes into account positive examples, the PAE that it produces will not be consistent in general. A consistent PAE covers all the positive examples for that attribute but excludes all of the negative examples for that attribute. However, the complexity of learning increases substantially when considering negative examples.

As shown in Appendix A, the consistent PAE problem is NP-complete.

The algorithm ConsistentPAE is a heuristic for determining a PAE that is consistent with respect to positive and negative examples of an attribute. The heuristic determines a distinguishing subsequence of symbols that are present in all the positive examples but not present in any of the negative examples for that attribute. Along with the set of positive examples (S+) and the set of negative examples (S) for an attribute, it also takes as its input the maximum possible length (K) of the distinguishing subsequence to be searched. The ontology identifies only positive examples for each attribute in a document. Therefore, the set of negative examples for an attribute is implicitly derived from the sets of positive examples for all other attributes.

ConsistentPAE(S+,S,K)
input
S+: a set of strings which serve as positive examples
S: a set of strings which serve as negative examples
K: the maximum length of a distinguishing subsequence
output
E: if E≠ε, then E is a PAE which is consistent with
respect to <S+,S>.
begin
1. F = {α|α is a common subsequence of S+ and |α|≦K}
2. for each α∈F do
3. if α is not a subsequence of β for all β∈S− then
4. n = |α|
5. α = χ₁χ₂...χₙ
6. for 1≦i≦n+1 do γᵢ=ε endfor
7. for each ρ∈S+ do
8. ρ=ρ₁ · χ₁ · ρ₂ · χ₂...ρₙ · χₙ · ρₙ₊₁
9. for 1≦i≦n+1 do γᵢ = γᵢ · ρᵢ endfor
10. endfor
11. Put a * on all symbols in γᵢ for all 1≦i≦n+1.
12. E = γ₁ · χ₁ · γ₂ · χ₂...γₙ · χₙ · γₙ₊₁
13. E = MakeNonredundant(E,S+)
14. return E
15. endif
16. end
17. E = ε
18. return E
end

In Line 1 of the method ConsistentPAE, the set F comprises all common subsequences of S+ and the length of any string in F is at most K. For each such string α, it is determined whether it is also a subsequence of any string in S. If it is not, then α is a distinguishing subsequence (Line 3).

Suppose a distinguishing subsequence comprises the symbols χ₁χ₂ . . . χₙ (Line 5). The heuristic constructs a (possibly redundant) consistent PAE of the form, γ₁·χ₁·γ₂·χ₂ . . . γₙ·χₙ·γₙ₊₁, where each γᵢ is a concatenation of all the symbols between χᵢ₋₁ and χᵢ over all the positive examples in S+ (Lines 7-10). There is a * on all the symbols in each γᵢ (Line 11) whereas there is no * over any of the symbols in α, the distinguishing sequence. As a result, the PAE generated this way does not accept any string in S. Finally, this newly constructed PAE (Line 12) is made nonredundant with respect to S+ by invoking the MakeNonredundant method (Line 13).

Observe that the method ConsistentPAE is a heuristic in the sense that it may not be able to discover a distinguishing subsequence of size at most K. In such a case, the procedure fails and returns the empty string (Line 17). The complexity of the method ConsistentPAE is polynomial time when K is fixed.

To generate a consistent PAE for the HospitalName attribute, the method ConsistentPAE is invoked with the path strings leading to “ABC Animal Hospital” and “XYZ Animal Hospital” as the positive examples. The path strings leading to “John, DVM”, “David, DVM”, “123-555-1000”, and “123-555-2000” serve as the negative examples. Note that these examples have been identified by the ontology as values for the other two attributes.

The font symbol distinguishes the two positive examples from the four negative examples. It corresponds to the distinguishing subsequence α=font in the algorithm ConsistentPAE. The path string for “ABC Animal Hospital” is represented as ρ₁·font·ρ₂, where ρ₁=table·tr·td and ρ₂=b·p. Similarly, the path string for “XYZ Animal Hospital” is represented as ρ₁·font·ρ₂, where ρ₁=table·tr·td·b·p and ρ₂=ε. Concatenation of the respective ρᵢ's and adding * on every symbol in them yields the redundant, consistent PAE, table*·tr*·td*·table*·tr*·td*·p*·b*·font·b*·p*. The determined nonredundant, consistent PAE is table·tr·td·p*·b*·font·b*·p*. Note that this PAE does not match any of the negative examples for the HospitalName attribute.

Referring now to learning unambiguous PAEs, to extract the data values for a set of attributes associated with a concept, a set of PAEs needs to be learned, one per attribute. The positive and negative examples used for learning a set of PAEs are obtained in the same way as for learning consistent PAEs. To extract data values from the source with very high recall and precision, it is desirable that this set of PAEs be unambiguous with respect to examples. However, the complexity of this problem turns out to be very high.

As discussed in Appendix A, the unambiguous PAEs problem is NP-complete.

Learning a set of PAEs that is unambiguous with respect to examples requires that each PAE in this set be consistent. Therefore, the method ConsistentPAE can be used repeatedly, once per attribute, as the heuristic for generating an unambiguous set of PAEs.

The PAE generated by the method LearnPAE can at times be consistent. Thus, before implementing the method ConsistentPAE, LearnPAE is used as an initial heuristic due to its relatively lower complexity. For example, LearnPAE generates the PAE table·tr·td·p for the PhoneNumber attribute which is also consistent. This PAE and the consistent PAE above for HospitalName form a set of PAEs that is unambiguous with respect to the examples identified by the ontology.

For an inherently unambiguous set of PAEs, the set needs to be unambiguous with respect to any example set. Such a set obtains 100% consistency and thus even higher recall and precision.

The inherently unambiguous PAEs problem is decidable. Given a set of sets of examples, {S₁, . . . , Sₙ}, if there exists a set of PAEs, {E₁, . . . , Eₙ}, which is inherently unambiguous with respect to {S₁, . . . , Sₙ}, then the size of each Eᵢ is bounded by the sum of the lengths of all the strings in Sᵢ. Each Eᵢ is enumerated and it is determined whether the resulting set of PAEs is inherently unambiguous with respect to {S₁, . . . , Sₙ}.

Given that learning a set of PAEs that is unambiguous with respect to examples is computationally difficult, heuristics need to be used. Since heuristics may not guarantee that all of the PAEs learned are consistent, ambiguity can occur when using such a set of PAEs for extracting data values of entities with multiple attributes. The method is based on bipartite graph matching that uses domain knowledge encoded in the ontology to resolve ambiguity as much as possible thereby improving recall while retaining high precision.

Assuming that PAEs are applied to each entity block, and that the attributes are single-valued, extending the above methods to multi-valued attributes is straightforward.

BipartiteResolution(E,D)
input
E: a set of PAEs representing attributes
D: a set of strings representing data values
output
A: a set of pairs in the form of (attribute,value)
begin
1. A = Ø
2. E = <E₁,...,En>
3. Let Eᵢ(1≦i≦n) be the PAE for the attribute Aᵢ.
4. m = |D|
5. Let αⱼ∈D(1≦j≦m) represent the data value Dⱼ.
6. G = Ø(G is the set of edges)
7. for 1≦i≦n do
8. for 1≦j≦m do
9. if αⱼ∈L(Eᵢ) then G = G∪{edge(Eᵢ,αⱼ)} endif
10. endfor
11. endfor
12. do
13. M = Ø
14. for 1≦i≦n do
15. if degree(Eᵢ) = 1 (edge(Eᵢ,αₖ)∈G for some αₖ) then
16. X = {Eⱼ|j≠i,edge(Eⱼ, αₖ)∈G, degree(Eⱼ) = 1}
17. if X = Ø then M = M ∪ {Eᵢ} endif
18. endif
19. endfor
20. for each Eᵢ∈M do
21. There must exist only one edge(Eᵢ,αₖ)∈G.
22. A = A ∪ (Aᵢ,Dₖ)
23. Remove all edges in G that are incident on αₖ.
24. endfor
25. while M ≠ Ø
26. return A
end

A PAE matches an attribute value whenever the path string terminating on the leaf node labeled with this value is accepted by the PAE. The ambiguity resolution algorithm takes as input a set of PAEs (E) and a set of data values (D) in an entity block that are matched by all the PAEs and returns a set of 1-1 associations between attributes and data values. Each data value comprises of a text string and the path string in the DOM tree that leads to this text string.

A method according to an embodiment of the present invention uses domain knowledge to resolve ambiguity. If a data value Dⱼ has been identified by the ontology as the value for an attribute Aᵢ, then the pair (Aᵢ,Dⱼ) is added to the set of associations for that record. The data value and the corresponding PAE are deleted from D and E, respectively.

A method derives more 1-1 associations between the remaining unresolved data values and PAEs using the method BipartiteResolution. BipartiteResolution constructs a bipartite graph in which the two disjoint sets of vertexes are E and D, respectively, and an edge between Eᵢ∈E and αⱼ∈D is created if Eᵢ matches αⱼ (Lines 2-11).

For example, given the three records of the DOM tree in FIG. 3 and the ontology in FIG. 4, suppose E₁=table·tr·td·p*·font*·b·font*·p* is the PAE learned for HospitalName, the PAE learned for DoctorName is E₂=table·tr·td·b*·p·b*, and the PAE learned for PhoneNumber is E₃=table·tr·td·p. Let D₁, D₂, and D₃ represent the data values (including their path strings) “Pets First”, “Tom”, and “(123) 555-3000” in the third record of the DOM tree, respectively. Then E₁ matches D₁ and D₂, E₂ matches D₂ and D₃, and E₃ matches D₃ only. None of these three data values was identified by the ontology. The bipartite graph created from the PAEs and the data values for this record is illustrated in FIG. 6(a).

If a PAE Eᵢ uniquely matches (the path string of) a data value αⱼ and no other PAE uniquely matches αⱼ, then a 1-1 association is made between Eᵢ and αⱼ (Lines 14-19). In other words, a high confidence is placed on a match of a data value by a PAE if this particular PAE does not match any other data values and no other PAEs uniquely match this data value. The edges are removed from those PAEs other than Eᵢ that point to αⱼ (Line 23). For example, in FIG. 6a, since E₃ uniquely matches D₃ the attribute PhoneNumber is associated with D₃ and all edges leading into D₃ are deleted. The residual bipartite graph is shown in FIG. 6b.

The determination is repeated until a “fixpoint” is reached, i.e., it is not possible to derive any more 1-1 associations. For example, in FIG. 6b, it is still possible to resolve more ambiguity because E₂ now uniquely matches D₂. As a result, the attribute DoctorName is associated with D₂ and all edges leading into D₂ are deleted. In the final residual graph there is a unique matching between E₁ and D₁. Thus, the attribute HospitalName is associated with D₁ and all edges leading into D1 are deleted. The method terminates now because no more unique associations can be derived, true in this case because there are no longer any edges in the graph.

However, it may happen that the ambiguity resolution method based on bipartite graphs is unable to derive any new association at all. For example, in FIG. 6c, the algorithm terminates without any new association because it is not possible to associate D₁ with either E₁ or E₂, as the condition is violated that a PAE should uniquely match a data value and no other PAEs should uniquely match this data value. Moreover, the ambiguity between E₃, E₄ and D₂, D₃ cannot be resolved either, as there is no unique matching.

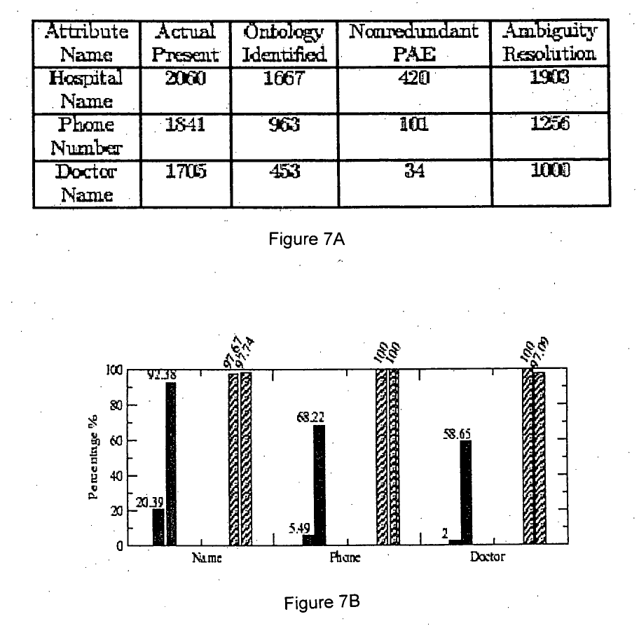

A data extraction system according to an embodiment of the present invention is based on the methods described above. The results shown in FIGS. 7a, 7b, 8a, 8b, 9a, and 9b were obtained by running the system for extracting attribute data from Web sources. The experimental setup comprised: identifying the domains, generating the data sets for those domains, creating an ontology for them, and executing the extraction process and manually validating the recall and precision metrics.

Two different domains were selected, veterinarian service providers and lighting products. For the veterinarian service referral pages such as the one shown in FIG. 2 were used. 170 such referral pages were collected from a number of different Web sites. For the lighting products 24 pages were collected pertaining to lighting products from 4 different Web sites: 2 from Kmart, 3 from OfficeMax, 13 from Staples, and 6 from Target. These pages are similar to that shown in FIG. 1.

For ontology creation the attributes characterizing the domain were fixed. These are the attributes that will be extracted. For veterinarian service providers the following three attributes were selected, namely, HospitalName, PhoneNumber, and DoctorName. The identifier functions were constructed. The attribute HospitalName is identified through a search for the keywords hospital and clinic, while for DoctorName the identifier function does a keyword search for the string DVM, an acronym for a veterinarian medical degree. The identifier function for PhoneNumber is a regular expression that will match any sequence that begins with 3 digits followed by a hyphen, followed by another 3 digits and another hyphen, and a terminating sequence of 4 digits. The ontology described above is shown in FIG. 4.

For lighting products the attributes are Name: and Price. Product names are identified by doing a keyword search on the words lamp, bulb, and tube, while product prices are identified by a using a keyword search on the “$” symbol. The corresponding ontology can be written as:
ontology(Lighting)={Name,Price}
Extractor(Name)=<keyword, {lamp; bulb; tube}>
Extractor(P rice)=<keyword, {$}>

Every page is parsed into a DOM tree and the entity blocks are identified (recall the boundary detection problem citeembleyrecord,icdm mentioned in Section 1). The identifier functions associated with the attributes in the ontology are applied to this tree. The paths leading to the leaf nodes matched by an identifier function become the positive examples for the attribute corresponding to the identifier function. Based on these examples PAEs are learned and applied to the entity blocks for extracting the attributes. The ambiguity resolution method described above is applied to the extracted data values to make 1-to-1 associations between them and the attributes. This amounts to a strong bias towards high-precision rules.

The recall and precision metrics of the extracted attribute are manually verified.

Non-Redundant PAEs and Ambiguity Resolution FIGS. 7a and 7b summarizes the recall & precision performance of extraction using non-redundant PAEs and the effect of ambiguity resolution. These results were aggregated over the 170 veterinarian web pages. In FIG. 7a the total count of the actual occurrences of each attribute (Column 2) over all the pages was ascertained manually. Column 3 shows the number of attribute values, which were identified by the corresponding identifier functions in the ontology. For example the identifier function for the Hospital Name attribute which does a keyword search on the string “hospital” and “clinic” identified 1667 names. Column 4 is the number of 1-1 associations between a non-redundant PAE and an attribute value. For example there were 420 such associations between hospital names and the non-redundant PAE for the Hospital Name attribute. Column 5 is the number of 1-1 associations between a non-redundant PAE and a attribute value that were made by the ambiguity resolution procedure. For instance it resolved 1903 hospital names uniquely. Correctness of an association was manually verified over all the pages.

FIG. 7b summarizes as a bar chart the recall (shaded bars) and precision (checkered bars) performance of the nonredundant PAEs for each of the three attributes, both before and after ambiguity resolution. Observe from the recall/precision bar charts that for all the three attributes there is a significant increase in recall with no loss in precision after ambiguity resolution. This shows that ambiguity resolution procedure is quite effective.

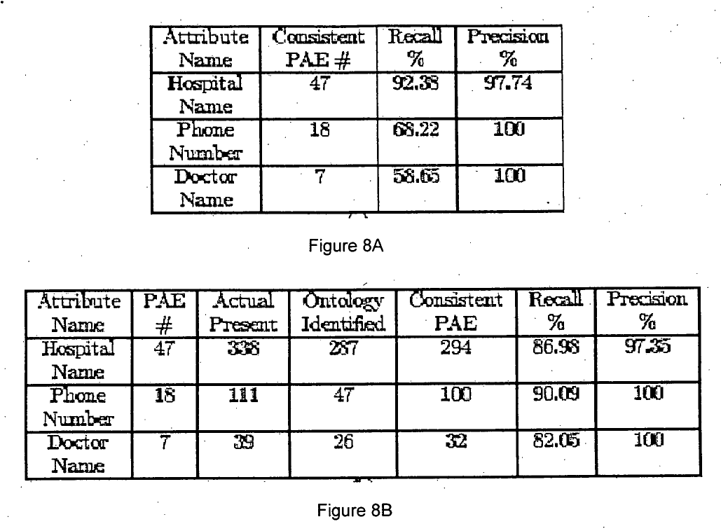

Referring to FIGS. 8a and 8b, in some cases the non-redundant PAE generated by algorithm LearnPAE also turns out to be consistent. This observation is used to identify consistent PAEs among the non-redundant PAEs generated by the algorithm LearnPAE on the veterinarian data. The recall and precision numbers were collected only for those web pages that generated such PAEs (see FIG. 8a). Referring to FIG. 8b, column 2 is the total number of web pages where the nonredundant PAE for an attribute was consistent. Columns 3 and 4 show the actual number of instances of that attribute in these pages and the number of instances identified by the ontology respectively. Column 5 is the count of correct (manually ascertained) attribute values extracted by the consistent PAE. Columns 6 and 7 are the recall and precision figures for the attributes based on the 1-1 associations made prior to ambiguity resolution. In contrast observe the relatively low recall of non-redundant PAEs prior to ambiguity resolution (see FIG. 7b). This experimentally validates that consistent PAEs have superior recall and precision than nonredundant PAEs.

For yet another evidence of the superiority of consistent PAEs, observe in FIG. 7b that after ambiguity resolution the recall of the name attribute is better than the phone, which in turn is better than that of the Doctors' name. The reason can be readily explained by the number of consistent PAEs for the corresponding attributes as shown in FIG. 4a. Observe that this number is highest for the name attribute and is the least for Doctor's name.

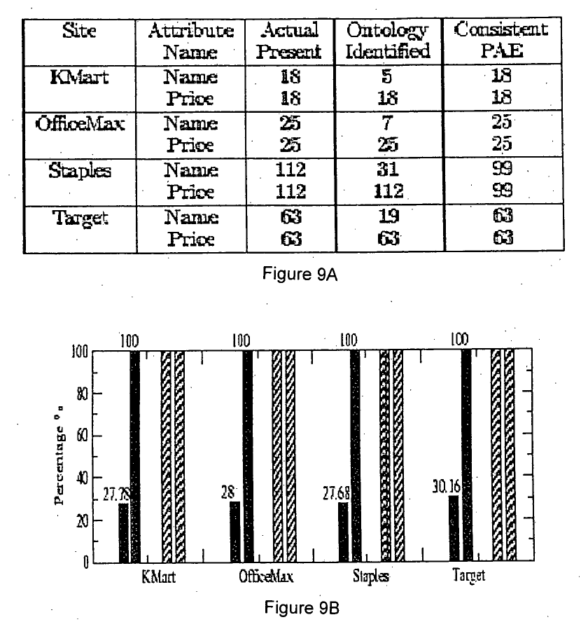

The method LearnPAE generated a pair of PAEs for extracting the name and price attribute from the lighting products pages of the four different web sites. These pages were all “well-structured” in the sense that the pair of PAEs generated by LearnPAE for each page turned out to be unambiguous with respect to the examples identified by the ontology. The raw recall numbers for both the attributes are shown in FIG. 9a. FIG. 9b compares the recall and precision of the consistent PAE learned for the product name to the recall and precision of the identifier function in the ontology for this attribute.

Observe that the recall as well as precision is both 100%, which experimentally demonstrates the superior quality of unambiguous set of PAEs.

Finally, it was observed that pages across these four different sites were widely dissimilar. The high recall and precision of extraction, in spite of this dissimilarity, obtained across all the four sites indicates scalability of our learning techniques.

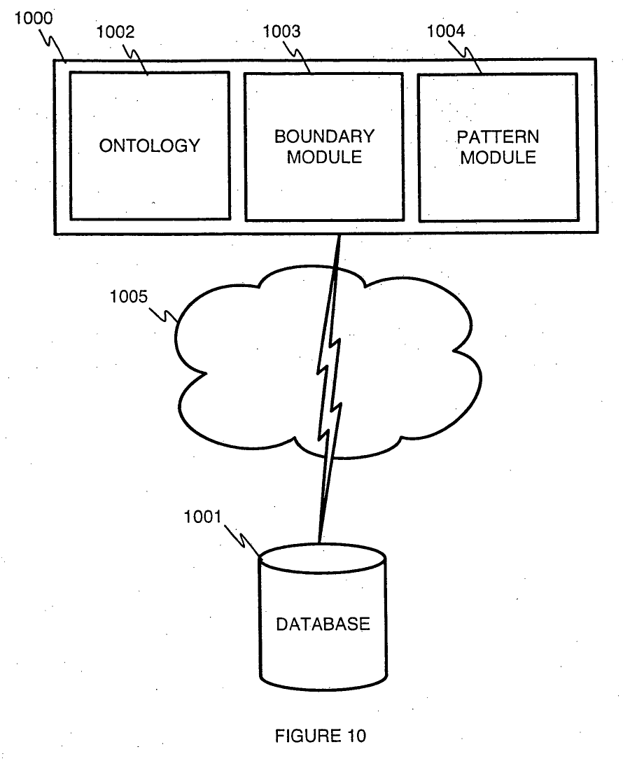

Referring now to FIG. 10, an adaptive search engine appliance 1000 for searching a database 1001 of multi-attribute data records in a template generated semi-structured document comprises an ontology 1002 for identifying a first set of attribute occurrences in the template generated semi-structured document, the ontology 1002 comprising a set of concepts and a set of attributes associated with every concept. The adaptive search engine 1000 further comprises a boundary module 1003 for determining a boundary of each multi-attribute data record in the template generated semi-structured document, and a pattern module 1004 for learning a pattern for an attribute corresponding to an identified attribute occurrence of the first set in the template generated semi-structured document, wherein the pattern is applied within the boundary of each multi-attribute data record in the template generated semi-structured document to extract a second set of attribute occurrences. The database 1001 of multi-attribute data records is stored on a server connected to the adaptive search engine application across a communications network 1005. Further exemplary elements of the adaptive search engine 1000 are illustrated in FIG. 5.

Having described embodiments for a method scalable data extraction from semi-structured documents, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

Appendix:

A. PROOF

Here we will present the proof of Theorem 1. The proof of Theorem 2 is similar to the proof presented here, but is omitted due to want of space.

In the sequel, ε is used to denote either the empty string or the empty expression. Its intended usage should be clear from the context. The notation α^{k}, where α is a string and k an integer, is used to represent the string obtained by repeating k times the string α. In particular, α°=ε.

Theorem 1 The consistent PAE problem is NP-complete.

Proof. Let POS and NEG be two sets of strings. Deciding whether or not a string is accepted by a PAE can be done in polynomial time. The size of the shortest PAE that is consistent with respect to <POS,NEG> is bounded by the sum of the lengths of the strings in POS. Therefore, this problem is in NP.

To prove that this problem is NP-hard, SAT is reduced to the problem. Assume the alphabet Σ={$, 0, 1}.

Let F be a propositional formula in conjunctive normal form with clauses C₁, C₂, . . . , Cₘ and variables V₁, V₂, . . . , Vₙ.

For 1≦i≦m and 1≦j≦n, let us define:

$${F}_{ij} \{ \begin{matrix}\$10 , & if {V}_{j} appears positively in {C}_{i} ; \\ \$01 , & if {V}_{j} appears negatively in {C}_{i} ; \\ \$00 , & if {V}_{j} does not appear in {C}_{i} .\end{matrix}$$

In a string $01 and $10 can be used to represent the logical values true and false, respectively. Thus for all 1≦i≦m, the string Fᵢ₁Fᵢ₂ . . . Fᵢₙ encodes the only assignment of truth values to the variables, V₁, V₂, . . . ,Vₙ, which makes the clause Cᵢ false. Moreover, define:
Pos={($0)ⁿ,($1)ⁿ}
NEG=N₁∪N₂∪N₃
N₁={$ⁿ⁺¹, 0$ⁿ,1$ⁿ}
N₂={$^{k}010$^{n-k}, $^{k}101$^{n-k}|1≦k≦n}
N₃={Fᵢ₁Fⁱ² . . . Fᵢₙ|1≦i≦m}

The formula F is satisfiable if there is a PAE that is a consistent with respect to <POS,NEG>.

Two PAEs, Eₜ=$0*1* and E_{f}=$1*0*, can be used to represent the logical values true and false, respectively. Given an assignment of truth values to the variables, V₁, V₂, . . . , Vₙ, in the formula F, a PAE can be constructed,

$${E}_{j} \{ \begin{matrix}{E}_{t} , & if the truth value assinged to {V}_{j} is true ; \\ {E}_{f} , & if the truth value assinged to {V}_{j} is false .\end{matrix}$$

So if the formula F is satisfiable, then there needs to be an assignment of truth values to the variables, V₁, V₂, . . . , Vₙ, which satisfies F. It can be shown that if a PAE, E, is constructed as defined above, then E is consistent with respect to <POS,NEG>.

Now suppose that there is a PAE, E, which is consistent with respect to <POS,NEG>. Then it follows that L(E) [symbol] POS and L(E)∩NEG=Ø. Assuming that E is in a compact form in which the consecutive occurrences of 0* or 1* are collapsed into one, since the resulted expression will still be equivalent to the original one. For instance, $0*1* is equivalent to $0*0*1*. Since L(E) [symbol] POS, a * operator must be attached to every occurrence of 0 and 1 in E. Because L(E)∩N₁=Ø, E needs to have the form of $α₁$α₂ . . . $αₙ, where each αᵢ is a sequence of 0* and 1* only. Moreover, both 0* and 1* must appear at least once in each αᵢ. Because L(E)∩N₂=Ø, it follows that each αᵢ is either 0*1* or 1*0*. Therefore, an assignment of truth values to the variables, V₁, V₂, . . . , Vₙ, can be obtained as defined above. Because L(E)∩N₃=Ø, it can be shown that this assignment needs to satisfy the formula F that is in conjunctive normal form.

Thus, |POS|+|NEG|=O(mn). Therefore the problem is NP-hard.

1. A method for extracting an attribute occurrence from template generated semi-structured document comprising multi-attribute data records comprising:
identifying a first set of attribute occurrences in the template generated semi-structured document using an ontology;
determining a boundary of each multi-attribute data record in the template generated semi-structured document;
learning a pattern for an attribute corresponding to an identified attribute occurrence of the first set in the template generated semi-structured document; and
applying the pattern within the boundary of each multi-attribute data record in the template generated semi-structured document to extract a second set of attribute occurrences.

2. The method for claim 1, further comprising the step of providing a seed ontology prior to identifying the first set of attribute occurrences.

3. The method of claim 1, wherein the ontology is one of a seed ontology and an enriched ontology.

4. The method of claim 1, further comprising enriching the ontology with the second set of attributes occurrences.

5. The method of claim 1, wherein the pattern is a path abstraction expression, wherein the path abstraction expression is a regular expression that does not comprise a union operator, and a closure operator only applies to single symbols.

6. The method of claim 1, wherein learning the pattern for each attribute occurrence comprises:
identifying the attribute occurrence in a data structure tree; and
determining the pattern of the attribute occurrence in the data structure tree.

7. The method of claim 6, further comprising the step of generalizing the pattern of the attribute occurrence prior to applying the pattern.

8. The method of claim 6, wherein the pattern comprises elements including a location and a format of the attribute occurrence.

9. The method of claim 8, wherein the elements are nodes in the data structure tree.

10. The method of claim 7, further comprising resolving the ambiguities in the extracted attribute occurrences comprising:
identifying attribute occurrences in the template generated semi-structured document matching more than one pattern;
determining a pattern that uniquely matches a given attribute occurrence and no other pattern uniquely matches the given attribute occurrence; and
eliminating matches between the given attribute occurrence and another pattern that matches the given attribute occurrence and at least one other attribute occurrence.

11. The method of claim 1, wherein learning the pattern for an attribute corresponding to an identified attribute occurrence of the first set in the template generated semi-structured document comprises:
learning positive examples of the attribute; and
learning negative examples of the attribute.

12. The method of claim 1, wherein learning the pattern for an attribute corresponding to an identified attribute occurrence of the first set in the template generated semi-structured document comprises:
determining a common supersequence for identified attribute occurrences corresponding to the attribute, wherein identified attribute occurrences are positive examples of the attribute;
determining a generalized supersequence by generalizing each term in the common supersequence; and
determining, for each term of the generalized supersequence, whether a term can be de-generalized.

13. The method of claim 1, wherein learning the pattern for an attribute corresponding to an identified attribute occurrence of the first set in the template generated semi-structured document comprises learning negative examples of the attribute, wherein the negative examples are positive examples of other attributes.

14. The method of claim 1, wherein determining the boundary of each multi-attribute data record comprises:
providing a tree of a page and a set of attribute names of a concept of the ontology;
marking a node in the tree by a set of attributes present in a subtree rooted at the node;
determining a set of maximally marked nodes in the tree;
determining a page type; and
extracting a boundary according to the page type.

15. The method of claim 14, wherein the page type is one of a home page and a referral page.

16. The method of claim 14, wherein extracting the boundary further comprises:
determining a maximally marked node with a highest score among the set of maximally marked nodes in the tree;
determining whether the tree comprises a single-valued attribute;
determining values of the single-marked attribute upon determining the single-valued attribute;
determining whether the tree comprises a multiple-valued attribute; and
determining values of the multiple-marked attribute upon determining the multiple-valued attribute.

17. A method for enriching an adaptive search engine comprising:
providing one of a seed ontology and an enriched ontology, the ontology comprising a set of concepts and a set of attributes associated with every concept;
determining an attribute identifier for a document of interest; and
adding the attribute identifier to the ontology for identifying attribute occurrences in at least the document of interest.

18. The method of claim 17, wherein determining the attribute identifier further comprises:
determining a methodology of the attribute identifier; and
determining a set of parameter values to be used by the methodology.

19. A program storage device readable by machine, tangibly embodying a program of instructions automatically executable by the machine to perform method steps for extracting an attribute occurrence from template generated semi-structured document comprising multi-attribute data records, the method steps comprising:
identifying a first set of attribute occurrences in the template generated semi-structured document using an ontology;
determining a boundary of each multi-attribute data record in the template generated semi-structured document;
learning a pattern for an attribute corresponding to an identified attribute occurrence of the first set in the template generated semi-structured document; and
applying the pattern within the boundary of each multi-attribute data record in the template generated semi-structured document to extract a second set of attribute occurrences.

20. An adaptive search engine appliance for searching a database of multi-attribute data records in a template generated semi-structured document, the search engine appliance comprising:
an ontology for identifying a first set of attribute occurrences in the template generated semi-structured document, the ontology comprising a set of concepts and a set of attributes associated with every concept;
a boundary module for determining a boundary of each multi-attribute data record in the template generated semi-structured document; and
a pattern module for learning a pattern for an attribute corresponding to an identified attribute occurrence of the first set in the template generated semi-structured document.

21. The adaptive search engine of claim 20, wherein the pattern is applied within the boundary of each multi-attribute data record in the template generated semi-structured document to extract a second set of attribute occurrences.

22. The adaptive search engine of claim 20, wherein the database of multi-attribute data records is stored on a server connected to the adaptive search engine application across a communications network.
